(19) United States
(12) Patent Application Publication
(10) Pub. No.: US 2010/0268640 A1
(43) Pub. Date: Oct. 21, 2010

(54) APPARATUS AND METHODS FOR RENEGOTIATING DEBT

(76) Inventors: Eric J. Kuyper, Los Alamitos, CA (US); Richard Wade Torkelson, San Clemente, CA (US)

Correspondence Address: J. MARK HOLLAND AND ASSOCIATES, 3 SAN JOAQUIN PLAZA, SUITE 210, NEWPORT BEACH, CA, 92660, US

(21) Appl. No.: 12/746,748

(22) PCT Filed: Dec. 8, 2008
(86) PCT No.: PCT/US2008/085980

§ 371 Date: Jun. 7, 2010

Related U.S. Application Data
(60) Provisional application No. 61/012,351, filed on Dec. 7, 2007.

(51) Int. Cl. G06Q 40/00; G06Q 10/00; G06F 17/30

(52) U.S. Cl. 705/38; 705/35; 707/802; 707/E17.005

(57) ABSTRACT

Apparatus and methods are disclosed for renegotiating debt payment terms and similar matters. A database 10 is accessible over a network by creditors 40 and debtors 30, who can populate the database 10 with relevant debt information and use that information to attempt to renegotiate terms for repayment of the debt(s). A wide variety of tools can be included within the database, to facilitate review of the debt information, monies potentially available to satisfy the debt(s), outcomes of various potential settlement approaches, “batch” decisions and actions on multiple debts, and related issues.

### CROSS-REFERENCE TO RELATED APPLICATION

This application claims priority to U.S. Provisional Patent Application Ser. No. 61/012,351, filed Dec. 7, 2007, the contents of which is incorporated herein by reference in its entirety.

### FIELD OF THE INVENTION

The present invention relates generally to apparatus and processes for gathering, processing, and analyzing debts and debt-related information, and facilitating decisions and other actions by debtors, creditors, and/or related parties. Among other things, the invention can facilitate batch decisions/actions/etc. to renegotiate the terms of certain debts.

### BACKGROUND OF THE INVENTION

As used herein, and unless indicated otherwise by the context, “creditor” is intended to have its normally broad meaning, and includes any person or entity who has advanced or loaned money or credit to another party, and/or anyone who is authorized to negotiate or act on behalf of such a creditor (including their agents, attorneys, credit card companies, banks, collection agencies, debt purchasers, etc.). Similarly, as used herein and unless indicated otherwise by the context, “debtor” is intended to have its normally broad meaning, and includes any person or entity who has received or borrowed money or credit from another party, and/or anyone who is authorized to negotiate or act on behalf of such a debtor (including their agents, attorneys, etc., as well as DSCs as discussed below). By way of example but not by way of limitation, “debtor” normally is intended herein to include consumers having debts such as credit card or other debts, and “creditor” normally is intended herein to include credit card companies or other entities providing those loans and/or that credit to consumers.

Financial relationships commonly include debt owed by a first party (a debtor) to a second party (a creditor). Among these relationships, some creditors provide loans or other forms of credit to a wide range and number of consumers or other debtors. Certain consumers/debtors may have multiple debts with a wide range and number of creditors.

In conventional economic settings and situations, such debts are commonly repaid upon specific schedules and/or other terms to which the parties have agreed. However, the parties sometimes desire or even need to renegotiate the terms of that debt or otherwise resolve issues that have arisen regarding the debt. For example, the debtor's economic situation may cause him or her to delay payment and/or even fail or otherwise be unable to pay the debt on the original terms/schedule/etc.

In modern societies, and as indicated above, a single debtor may owe money to many different creditors, including (for example) banks, credit card companies, etc. Accordingly, when a debtor has difficulties or is unable to service some or all of his or her debt, commonly there can be a number of creditors who are affected. In turn, and as also indicated above, those creditors (the banks, credit card companies, etc.) typically have provided loans or credit in some form to many different debtors. Statistically, at any given point in time, some percentage of those debts will be in or near the condition described above—the debtor being unable to service or repay the debt upon its original terms.

In such situations, creditors may be willing to renegotiate the debt (to take a reduced payment or negotiate different payment terms). Some creditors may prefer that approach to possible alternatives such as being forced to undertake the uncertainty, risk, and expense of settlement collection efforts based on the original debt terms (including by way of example, using collection agencies or even suing to collect the debt) and/or possibly recovering nothing (such as if the debtor declares bankruptcy or uses its limited assets to pay a different creditor or creditors).

The stress, complexity, and or other factors associated with such situations have led to the formation of companies and businesses that assist debtors in resolving their debts. Such companies are sometimes referred to as “debt resolution”, “debt settlement”, and/or “credit counseling” companies, and they commonly represent many separate, independent debtors. For each such “debtor” client, the companies typically represent that debtor for “all” of the debts that debtor is hoping to resolve or renegotiate, including debts to multiple/different creditors. As used herein and unless indicated otherwise by the context, “debt settlement company” or “DSC” is intended to have its normally broad meaning, and includes all of the foregoing companies and entities, and/or any person or entity acting to assist debtors in resolving their debts, or one who stands in place of that borrowing person or entity.

Thus, almost by the definition of what a DSC does, a series of sometimes complex and overlapping relationships can arise among DSCs and creditors (especially ones such as banks or credit card companies). Among other things, such creditors commonly first have to figure out what (if any) DSC is representing the debtor, and then negotiate with that DSC, frequently on an account-by-account basis. In some ways creditors view this situation as an improvement over dealing directly with the debtor (because the creditor gets to deal with a relatively unemotional third party—the DSC). In other ways (such as the requirement for individual, account-by-account handling of those debts), this approach is not greatly different from dealing directly with each debtor.

In some of these situations, the renegotiation involves a corresponding “savings” plan by the debtor. At least two such models are currently in use: (a) a third party trust vendor/account who receives from the debtor certain payments that are intended to be applied to that debtor's debt(s), and (b) a “self-saver” model, in which the debtor himself (or herself) administers the savings/payments toward the debts. Although there are costs and benefits associated with each of those models (and presumably with other such models), the third party trust vendor/account can provide some increased incentive for renegotiation by the creditor(s), because that model (and its inclusion of a neutral third party's actual possession of certain of the debtor's funds) typically better ensures that actual payment to the creditor (on the renegotiated terms or otherwise) will occur, rather than the debtor simply failing yet again to service the debt (even on the renegotiated terms).

In the foregoing situations, the DSCs (or even the debtors themselves) also often have to attempt to “manually” negotiate with each of the creditors for a particular debtor, but such activities can be so time- and/or labor-intensive as to be uneconomic for the creditor (or its agents), the debtor (or his/her agents), or for both parties. In addition to being uneconomic, such “manual/individual” negotiations can increase the likelihood of an adversarial or even hostile atmosphere in the negotiations, sometimes making it more difficult for the negotiating parties to focus on the economic aspects of the situation and reach an agreeable resolution. Even when a resolution is reached, the emotional burden of the negotiations on the debtor and creditor (and/or the individual persons involved on their behalf) can be substantial. This is especially true in situations where there is a “cumulative stress” effect (such as on a debtor with multiple debts).

### SUMMARY OF THE INVENTION

The present invention is directed to improving the apparatus and processes available and used to resolve various debt situations. Among other things, it is useful in connection with DSCs, and enables efficient interaction between those companies (and/or the debtors that they represent) and those debtors' creditors. Among the invention's many uses, objects, and advantages is the batch processing of multiple claims by creditors related to the debt of multiple independent debtors.

In other embodiments of the invention, debtors and creditors can interact “directly” with each other, without the expense or procedural overhead and delay of DSCs, collection agencies, or the like. Although a third party trust vendor can be included and utilized in certain embodiments, other embodiments can include a “self-saver” or other approach by the debtor. In many of the embodiments of the invention, the process of renegotiating the terms of the debt can be significantly streamlined, saving time, effort, stress, and money on the part of both the creditor and/or debtor. By reducing the “overhead” that is inherent in conventional systems (involving collection agencies, attorneys litigating or otherwise corresponding/negotiating on behalf of the parties, etc.), the likelihood of resolution of such debts is increased, in part because more of the debtor's resources can be applied to the debt itself.

The description and the figures set forth herein are directed to a few of the many embodiments, objects, and advantages of the invention. Many other embodiments, objects, and advantages will be apparent from the description and the figures. The invention is not limited to any particular embodiment(s) disclosed.

Any particular one embodiment of the invention may not achieve all of the various objects or advantages of the invention. Thus, for example, the invention may be embodied or carried out in a manner that achieves or optimizes one advantage or group of advantages without necessarily achieving other objects or advantages that may be taught or suggested.

### BRIEF DESCRIPTION OF THE DRAWINGS

FIG. 1 illustrates a flowchart overview of one embodiment of the present invention.

FIGS. 2-9 graphically illustrate the various steps of the embodiment of FIG. 1.

FIG. 10 is a representative computer screenshot of one embodiment of a form/report that may be provided to practice the invention.

### DETAILED DESCRIPTION

Embodiments of the present invention will now be described with references to the accompanying Figures, wherein like reference numerals refer to like elements throughout. Although the terminology is being used herein in conjunction with a detailed description of certain embodiments of the invention, that language is not intended to be interpreted in any limited or restrictive manner. Furthermore, various embodiments of the invention (whether or not specifically described) may include novel features, no single one of which is solely responsible for its desirable attributes or which is essential to practicing the invention described.

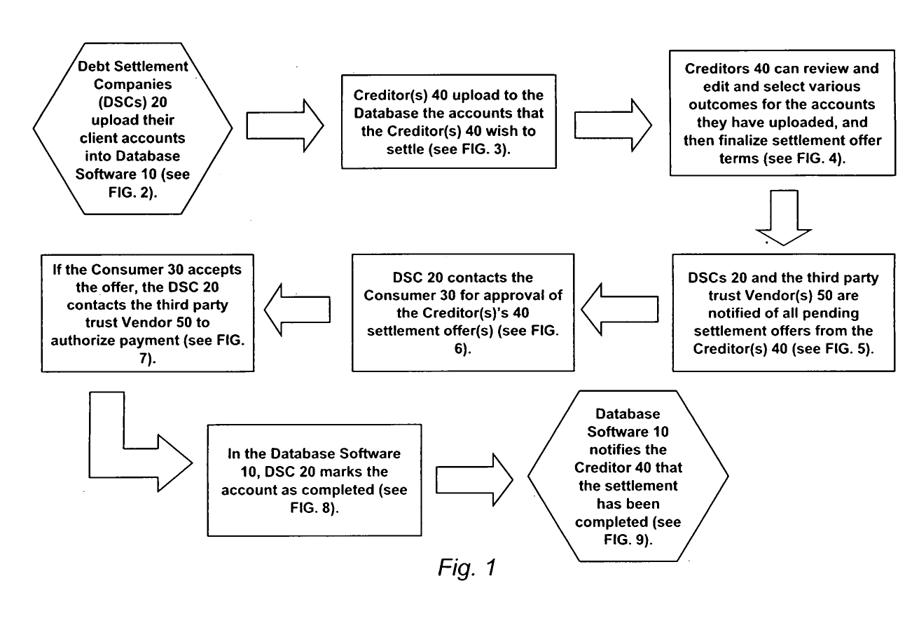

An overview of one embodiment of the invention is illustrated in FIG. 1, which is a flow chart showing a system/method/apparatus to help resolve or renegotiate certain consumer debts. Certain of the steps can occur in different orders and even relatively simultaneously and independently of one another. For example, in the embodiment of the invention that is illustrated in FIG. 1, one or more Debt Settlement Companies (DSCs) can upload their client (debtor) accounts into a Database Software, and one or more Creditors likewise can upload into the Database Software the account or accounts that the Creditor wishes to settle. These uploads can occur independently of each other, in stages, and in no particular order, although in this embodiment, both need to occur prior to certain other steps in the method.

The Database Software of the invention can be any suitably secure, accessible tool that can be used in the desired operating environment. Among other things, networks such as the Internet, virtual private networks (VPNs), or other forms of electronic communication can be used.

There are several ways that debt accounts can get “into” the system of the invention, including by way of example: (1) the system can be marketed or otherwise be made available directly to debtors/consumers; (2) creditor(s) referring the debtor to the database service of the invention; (3) DSCs and/or attorneys for the Debtors suggesting that the Debtor use the database service/system of the invention, and/or (4) DSC's and/or attorneys for the Debtors uploading accounts on behalf of the debtors as part of their normal business process.

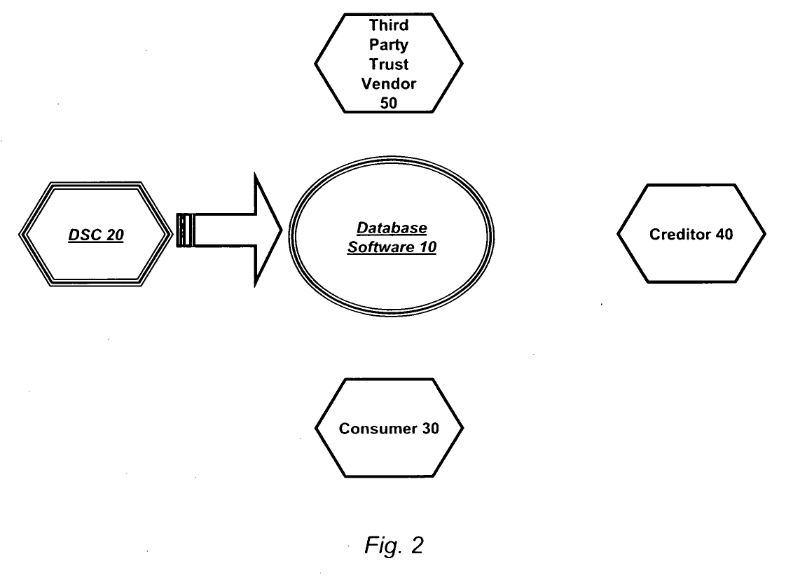

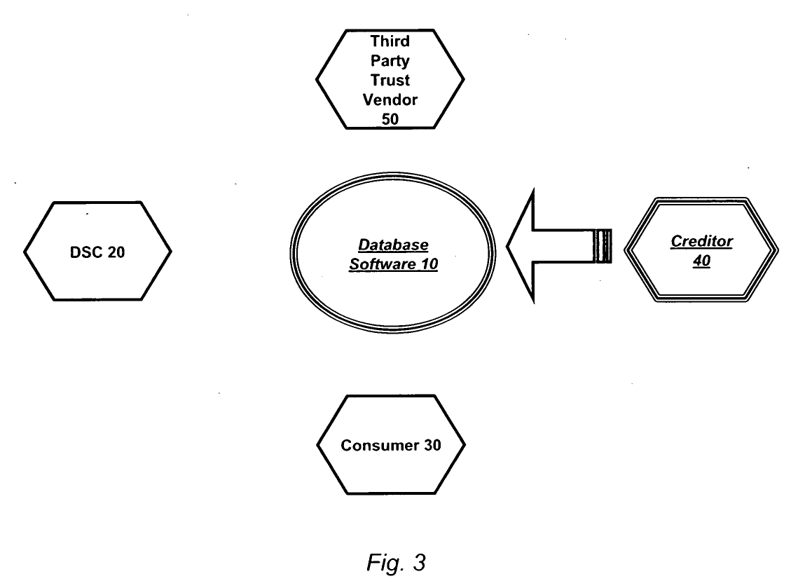

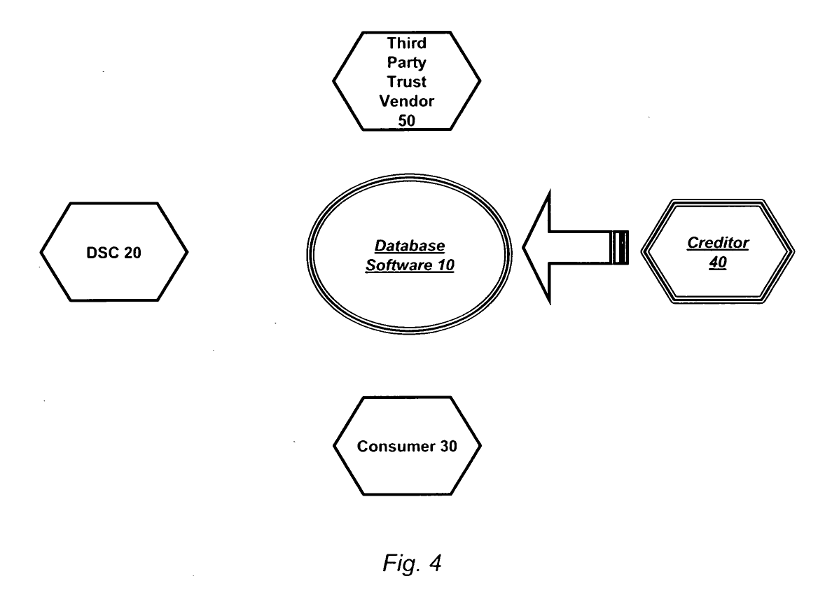

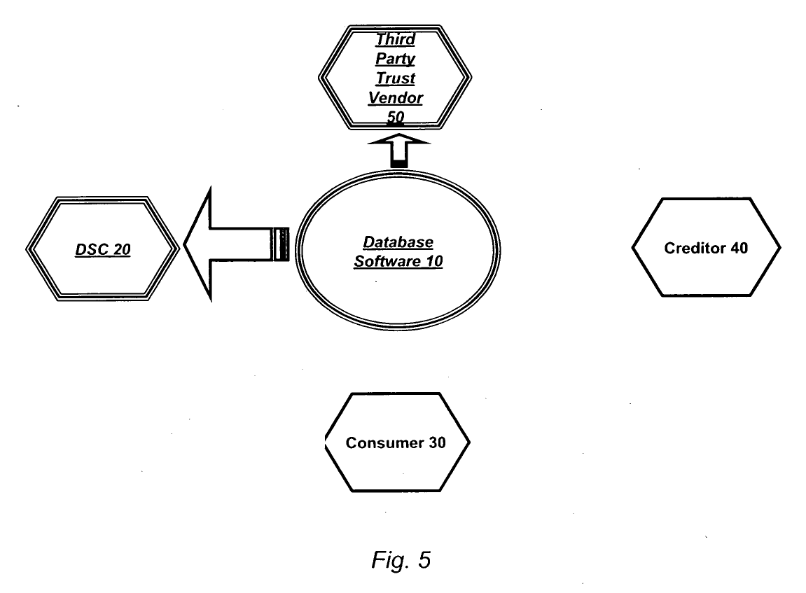

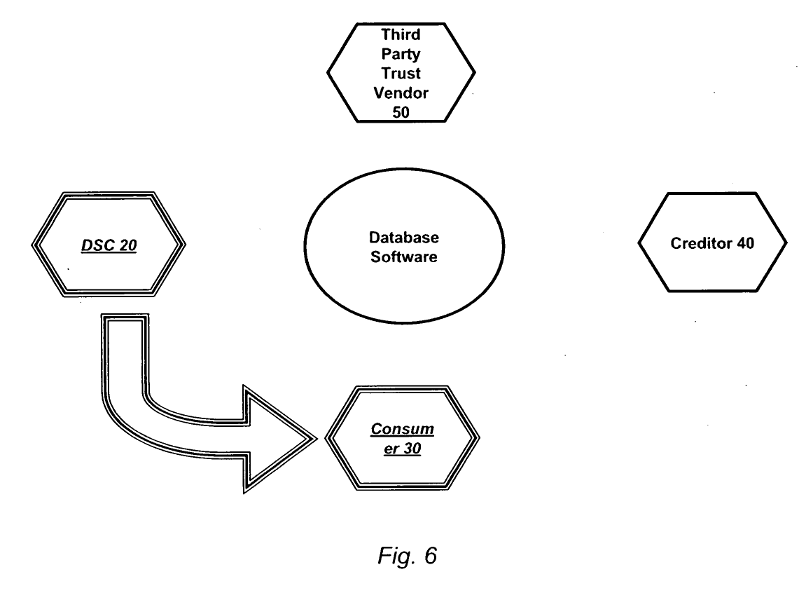

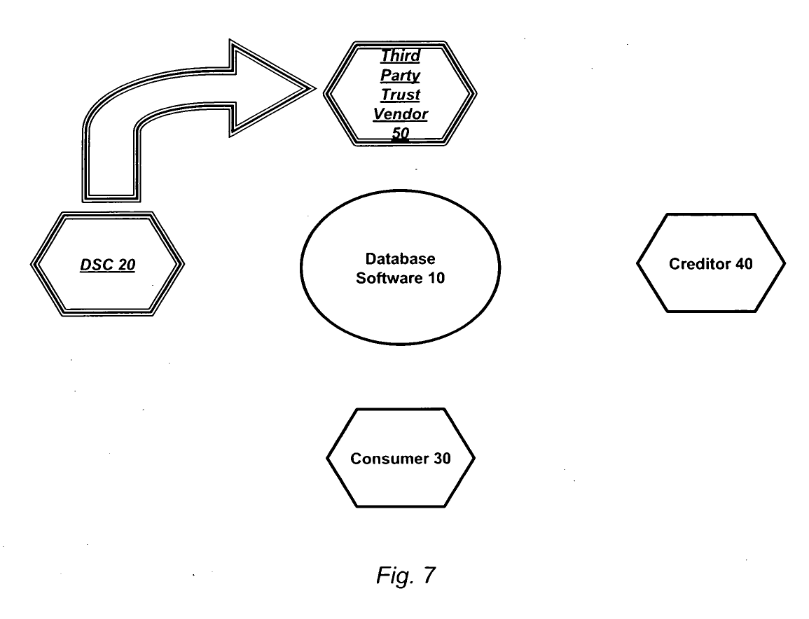

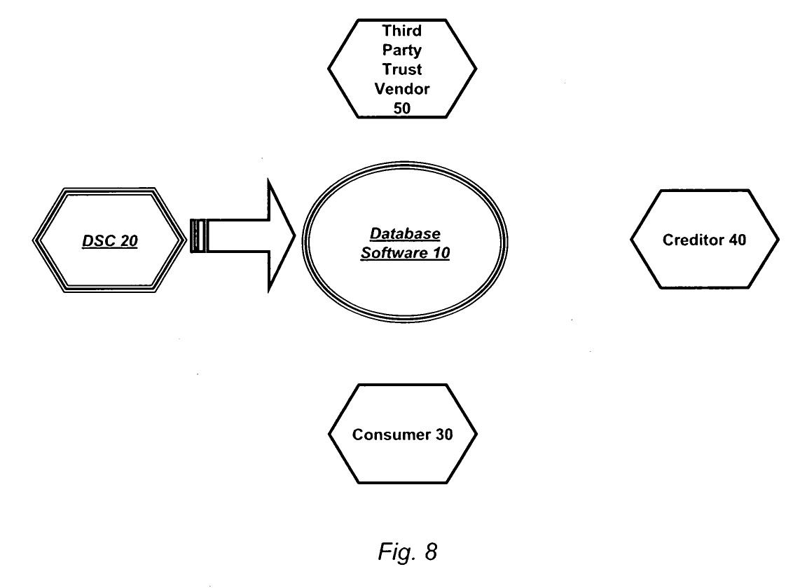

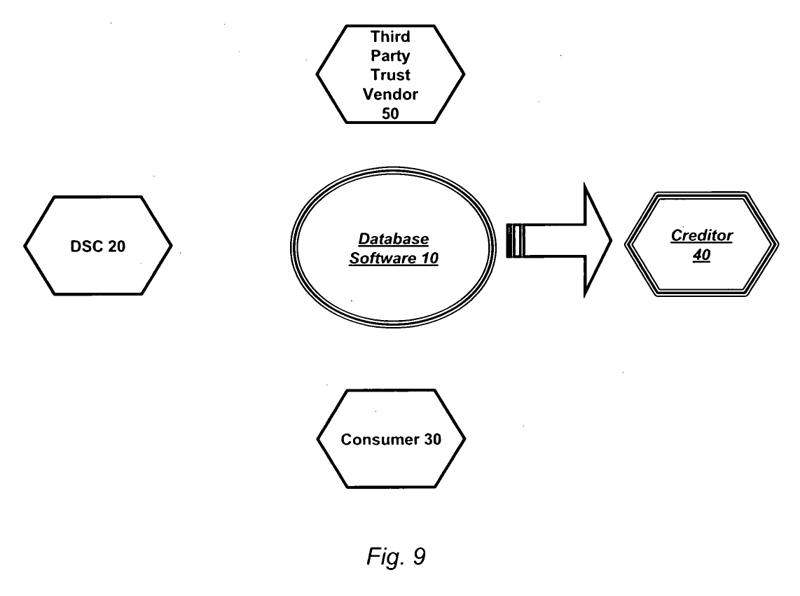

The steps of the method of FIG. 1 are shown in greater detail in FIGS. 2-9, respectively. Each of those FIGS. 2-9 includes a graphic representation of the Database Software 10, the Debt Settlement Companies (DSCs) 20, the Debtor(s) 30, the Creditor(s) 40, and the Third Party Trust Vendor(s) 50. For each step, the “active” participants from the graph are highlighted by bold outlining of the relevant graphic shape and underlining of the enclosed text:
A. Through a suitably secure web portal or any other suitable interface, Debt Settlement Companies (DSCs) 20 can upload the accounts for their client (Debtor(s) 30) into Database Software 10 (see FIG. 2 for details). Among the many alternative embodiments of the invention (not shown), the Debtor(s) 30 can upload their account information directly into the software 10 (without the use of a DSC). For each uploaded account, the DSC and/or Debtor can set parameters for acceptable settlement/renegotiated terms for the debt. If a Third Party Trust Vendor 50 (TPTV) is involved, the parameters set by the Debtor/DSC can include some or all of the balance being held by that TPTV on behalf of the Debtor 30 (the portion of that balance that the Debtor is willing to make available to resolve the Debtor's debt(s)). In one embodiment, those parameters (such as the TPTV balance that the Debtor has authorized for disclosure or “pre-approved settlement funds”) will be viewable by Creditors 40 associated with the Debtor's debt(s). In certain embodiments, the invention can be practiced by requiring and/or allowing the Debtor to make “viewable” all of the TPTV balance. If no TPTV is involved but the Debtor is undertaking a “self-saver” approach, the “saved” balance similarly can be uploaded by the Debtor or DSC and made viewable (in whole or in part). In such a “self-saver approach, the “saved” balance can include a balance which is estimated by the Debtor or DSC, or a means for calculating the approximate amount of monies available for settlement of the Debtor's debt(s) can be provided. Depending on many factors, the invention can be used to apply any such balance in a variety of ways, such as by calculating a pro rata percentage (or a flat percentage) of the original debt balance(s), or by any other useful formula or process.
B. Through a suitably secure web portal or any other suitable interface, in one embodiment the Creditor(s) 40 can upload to the Database 10 the accounts that the Creditors 40 wish to settle (see FIG. 3 for details). In this embodiment (or in certain other embodiments that do not involve any “upload” by Creditors), the Creditors 40 can securely log in to view any accounts related to them, without having actually “uploaded” information themselves (see FIG. 4 for details)—the data uploaded by the Debtor/DSC preferably would include sufficient information to associate and make searchable/viewable all of those accounts that are related to a particular original Creditor (such an a major national bank), when that Creditor logs into the database (this is in contrast to the information that preferably would be viewable by a collection agency or other agent representing multiple Creditors—see, for example the discussion herein regarding certain embodiments of the invention that distinguish between an original creditor and a collection agency). For accounts associated with a Creditor, various forms and reports can be made available (in certain embodiments of the invention) for the Creditor's review, such as that Creditor's accounts for which the Debtor/DSC has authorized payment terms that meet or exceed a certain percentage of the debt owed on the account. The Creditor can use this information to formulate a proposed settlement/renegotiation strategy or offer for one or for many accounts. By way of example, in certain embodiments of the invention, a Creditor can view all of its accounts in the database for which the associated Debtor/DSC has authorized payment of 40% or lower of the outstanding balance, and/or its accounts for which the TPTV payment balance available (and that the Debtor/DSC has authorized as viewable) exceeds $500 (with the 40% and $500 being parameters selectable by the Creditor 40). Of those, the Creditor(s) 40 preferably can easily select (“accept”) one or more of those settlement/renegotiation proposals (if more than one, the selection would be a “batch”) from the database interface, thereby moving the process to the next step. Depending on the application and the particular embodiment of the invention, the access portal/interface(s)/databases for the Creditor(s) and Debtor(s) can be “separate” from one another to at least some degree, and/or can be combined into a “single” interface. Especially if one or more users or types of users are combined into a “single” portal, the invention preferably includes controls in the portal to limit the various different views and/or functionality and/or other controls available to a given user of the portal. By way of example, such controls can be based on the user's login information or other convenient criteria. In one embodiment, access and/or security protocols are provided to ensure that information access is controlled appropriately as between (a) Debtor/DSC users of the web portal and (b) Creditor 40 users of the web portal.
C. The DSCs 20 and the Third Party Trust Vendor(s) 50 are notified of all pending settlement offers from the Creditor(s) 40 (see FIG. 5 for details).
D. The DSC 20 contacts the Debtor 30 for approval of the Creditor(s)'s settlement offer(s) (see FIG. 6 for details).
E. If the Debtor 30 accepts the offer, the DSC 20 contacts the Third Party Trust Vendor(s) 50 to authorize payment (see FIG. 7 for details). For alternative embodiments not involving a TPTV, the Debtor 30 can make the payment(s) directly. If no DSC 20 is used in a given embodiment of the invention, the Debtor 30 or other agent of the Debtor can authorize payment by the TPTV or otherwise arrange for the appropriate payment(s).
F. In the Database Software 10, the DSC 20 marks the account as completed (see FIG. 8 for details). Again, in alternative embodiments, the Debtor 30 or other agent of the Debtor can update the Database Software 10 in that regard.
G. Preferably, upon being updated in the previous step the Database Software 10 automatically notifies the Creditor 40 that the settlement has been completed (see FIG. 9 for details).

In other embodiments, or as an additional feature of the foregoing embodiments, a “Comments” field or other communication channel can be provided within or coordinated with the Database Software 10. Among other things, this can facilitate “custom” negotiation or other communication among (a) the Creditor (or its agents) and (b) the Debtor (or his/her agents). By way of example, these communications could include inquiries and/or explanations for either party's positions, facts, or circumstances that may make it appropriate to treat the particular debt as an exceptional situation (thereby justifying a higher/lower payment or other terms), etc.

Many other features can be added or substituted within the foregoing process, the Database Software 10, or otherwise, all without departing from the spirit and scope of the invention.

In many of the wide variety of embodiments of the invention, the “Creditors side” upload/process can be executed by actual Creditors or by anyone legally authorized to negotiate on the relevant debt. Similarly, the Debtors/DSC side of the upload/process can be undertaken or otherwise effectuated by anyone legally authorized to represent or otherwise take actions on that specific debt.

As indicated above, the invention can be practiced in a wide variety of embodiments, selected based on a number of arbitrary and/or objective variables. Among other things, participation by DSCs and/or Debtors may be encouraged by allowing them to control the information that is viewable/reviewable by the Creditors. On the other hand, Creditors might prefer that they be given absolute review of the complete/full balance available within a Debtor's TPTV account, the settlement limits that the Debtor 30 has authorized, etc. Depending on the situation and subject to other factors such as appropriate notice to participants in the system, these parameters can be modified to “tweak” various embodiments of the system, alternative user portals can be opened (with other criteria/parameters/etc.), and other changes can be readily adopted/incorporated into the system. In other words, the apparatus and methods of the invention preferably provide a substantial degree of flexibility so that they can be adopted to a wide variety of markets and situations.

Among its many advantages, the invention can provide much more “direct” and efficient interaction between debtors and creditors, and can provide a wide variety of methodologies for reaching agreement between those debtors and creditors for resolution of their debt claim(s).

In one embodiment, the invention can be practiced as an Internet/intranet based application that is administered and run by a neutral third party. The invention facilitates aggregating debtors accounts from multiple sources to a data repository, allows creditors to make inquiries into the data repository to see what monies are available to settle debt, and allows debt settlement companies to complete batch settlements with creditors and collection agencies.

In certain embodiments, the invention includes an Internet web portal that allows creditors or collectors to generate batch settlement offers to clients/debtors, even if those debtors are enrolled in a variety of settlement programs across multiple front-end companies such as DSCs. The invention provides tools to generate a batch settlement based on actual dollars consumers hold in trust fund reserves (such as TPTVs). Creditors can make a specific percentage or dollar offer, or utilize another method of the invention to calculate the greatest dollar return possible based on the accounts submitted, the available balances, and the settlement criteria specific to each account enrolled. The invention also preferably can provide an audit trail following the settlement offers back to the debtor/consumer or the consumer's representative (such as a DSC), to the third party trust (if any), and finally to payment of the creditor or collector. Some of the many various embodiments of the invention are further compared and contrasted below.

In one of its embodiments, the invention preferably includes at least three major components:

Data Repository. The database of the invention preferably includes an SQL or similar back-end that contains data such as credit card numbers, balances, accumulated savings, and which debt settlement company is servicing this debt. Preferably, this data is updated regularly by the participating debt settlement companies. Additional tables can contain historical transactional data, debt settlement company profiles, and creditor settlement campaigns. As used herein, a “campaign” includes a batch or group of debts (in the form of a batch of credit card accounts, electronic data, or otherwise) that are submitted and/or selected by a Creditor. The criteria used by any particular Creditor to determine which debts/data/cards to include in any given “campaign” can vary widely and be based on any useful information about the debts/cards/data. Preferably, cards or other debts selected for a given campaign are ones on which the Creditor is willing to negotiate, and preferably all cards or other debt accounts within a given campaign will have a similar status (so that the Creditor would be willing to make similar offers to the Debtors represented by each of the debts within the given campaign). However, the particular details of any given embodiment of the invention can be modified in a wide variety of ways. By way of example, smaller credit agencies might elect to include all of their accounts, and then compare any matches line-by-line (“manually”) to see what they might want to propose to further negotiate some or all of those debts. Preferably, at any given time, a Creditor can submit/prosecute one or multiple campaigns, each campaign having similar or varying criteria.

Web Portals. In certain embodiments of the invention, two main portals (one for debt settlement companies/Debtors, and one for creditors) preferably comprise the primary user interfaces. The portals provide the user access to the database, as described herein. The debt settlement web portal allows for updating debtor information, reviewing and completing existing settlement offers, and viewing/downloading completed transaction information. The creditor portal allows for uploading lists of credit card accounts, conducting individual or batch settlements, or utilizing the “Maximum Recovery” mode or other modes of the invention, whereby the collector/Creditor can request settlements focusing on either maximum dollars or highest percentages. Preferably, all data provided by the web portals will also be available as an XML data file or in some similarly useful format for ready download or other uses. As indicated above, depending on the application and particular embodiment of the invention, the access portal(s)/interface(s) for the Creditor(s) and Debtor(s) can be separate from one another, and/or can be combined into a “single” interface with controls to restrict the information available to any given user.

Depending on the particular embodiment of the invention, a portal or interface for a “campaign/upload” screen might include one or more of the following features usable by the Creditor:
Upload file—this from creditors can include and/or require the debtor(s) Credit Card account number, current balance, and an optional offer field. For convenience and/or clarity, the system and/or the Creditor portal/interface preferably can make clear to users that offers under “100” are considered to be percentages of the outstanding debt, and those over “100” are considered to be dollar offers.
If a Creditor uploads a percentage (either as an offer or as a percentage), the system can automatically mark the record as being Submitted, rather than requiring the Creditor to also press a separate button for a given record or records or take some other action.
the “Amount Owed” by the Debtor can alternatively be called the “Enrolled Balance” (e.g., the amount that the Debtor has “enrolled” into the system of the invention). Similarly, the “Savings Balance” displayed for any given Debtor/debt can be called “Pre-approved settlement dollars” that the Debtor has made available to the system.
In the “campaign” screen, above entry fields such as “maximum recovery” and “flat recovery”, radio buttons can be provided (such as one labeled “Calculate against Current” and one labeled “Calculate against Enrolled” (or Original Balance). Such buttons can control how offers entered as a percentage should be interpreted for that embodiment of the invention, as well as percentages entered into the “maximum recovery” and “flat recovery” fields.
The “offer” field preferably will accept either dollar or percentage figures, but preferably will always display as a dollar amount. As indicated above, entering a number under 100 preferably is interpreted by the database as a percentage, and entering a number over 100 as a dollar amount.

In one embodiment, an overall screen layout can thus include information such as the following, displayed in any convenient form or layout:

| | | | | Preapproved | | |
|---|---|---|---|---|---|---|
| Account | | Enrolled | Current | Settlement | | |
| Holder | Account Number | Balance | Balance | Dollars | Offer | Submit |
| 8755 | 5178052464776240 | 1712.00 (0%) | 2119.34 (0%) | 684.80 | | □ |

In the embodiment above, the current balance is included and the percentage figure is removed from the Amount Preapproved (savings balance). The Preapproved Settlement Dollars are still 40% of the original balance (or whatever percentage the DSC/Debtor decides). The percentage figure is displayed for both balances based on the current offer. The above example illustrates what might be displayed where a Creditor has uploaded a campaign with no uploaded offers, and has yet to play with the “maximum recovery” and “flat recovery” fields/functions of the invention.

If the Creditor then uses the radio button marked “Calculate against Current” and enters 40% in the “flat recovery” field, the above table would be updated as indicated below:

| | | | | Preapproved | | |
|---|---|---|---|---|---|---|
| Account | | Enrolled | Current | Settlement | | |
| Holder | Account Number | Balance | Balance | Dollars | Offer | Submit |
| 8755 | 5178052464776240 | 1712.00 (49.5%) | 2119.34 (40%) | 684.80 | 847.73 | □ |

In the above example, the 40% flat recovery was converted to an offer of $847.73, and the Enrolled Balance and Current Balance fields had their percentages updated. The submit button is blank because the Creditor's proposed “offer” exceeds the amount that the Debtor has pre-approved.

In the next example or scenario, the Creditor uploads a campaign with no uploaded offers, and manually types in “35” in the offer column while the radio button is set for “Calculate against Current”. This results in a display such as the following:

| | | | | Preapproved | | |
|---|---|---|---|---|---|---|
| Account | | Enrolled | Current | Settlement | | |
| Holder | Account Number | Balance | Balance | Dollars | Offer | Submit |
| 8755 | 5178052464776240 | 1712.00 (43.3%) | 2119.34 (35%) | 684.80 | 741.77 | [symbol] |

As before, this embodiment of the system takes the amount entered (35) and based on the rules assumes that number is a percentage. Enrolled Balance and Current Balance percentages are updated according to that percentage. Additionally, because the Creditor manually entered an amount there, preferably the system automatically checks (fills in) the “submit” button, since there is an obvious intent by the Creditor to make a settlement offer.

In a final example or scenario, a Creditor uploads a file with no uploaded offers, and does a “maximum recovery” campaign of 30% with the “Calculate against Current” radio button selected. The information can be displayed in a manner such as the following:

| | | | | Preapproved | | |
|---|---|---|---|---|---|---|
| Account | | Enrolled | Current | Settlement | | |
| Holder | Account Number | Balance | Balance | Dollars | Offer | Submit |
| 8755 | 5178052464776240 | 1712.00 (40.0%) | 2119.34 (32.3%) | 684.80 | 684.80 | [symbol] |

Because the 30% entered by the Creditor is less than the amount that the Debtor has pre-approved, the Creditor's settlement offer is increased (raised) to the Debtor's pre-approved settlement amount, and the percentages are updated accordingly.

Thus, within the exemplary embodiment just described, when a Creditor elects to use a “maximum recovery” or “flat recovery” method or approach, the “submit” box adjacent the relevant offer data is automatically checked only if the calculated offer is less than or equal to the Amount Preapproved by the Debtor. Any time a Creditor either manually types in an offer or uploads one, the “submit” box is checked regardless of the amount preapproved by the Debtor.

Among the many additional and alternative tools that can be included in the database user interfaces of the invention, additional statistics boxes or fields can be displayed at the bottom of any given screen. Such boxes can display any useful information, such as the same figures as described in the examples above, but for “out of range” debts/settlements.

At the bottom of appropriate display screens, various embodiments of the invention can include a “check all” checkbox, which can be programmed (for example) to check all the entries within a campaign that have a non-zero offer (thereby eliminating the need for the Creditor/user to manually check ALL such boxes). Likewise a button can be provided to “uncheck all”.

In addition, various embodiments of the invention can include a tool which generates the actual amount required to settle a debt in the form of a “letter” from the Creditor. This feature can be programmed to generate a “letter” whenever the Creditor selects an offer to make.

As also indicated above, certain embodiments can sort and/or filter records in helpful manners. For example, to display most “hits” at the top of a given screen, the embodiment can be programmed to sort by and display the relevant Debtors' by percentage of savings balance (or pre-approved settlement dollars) to Enrolled Balance.

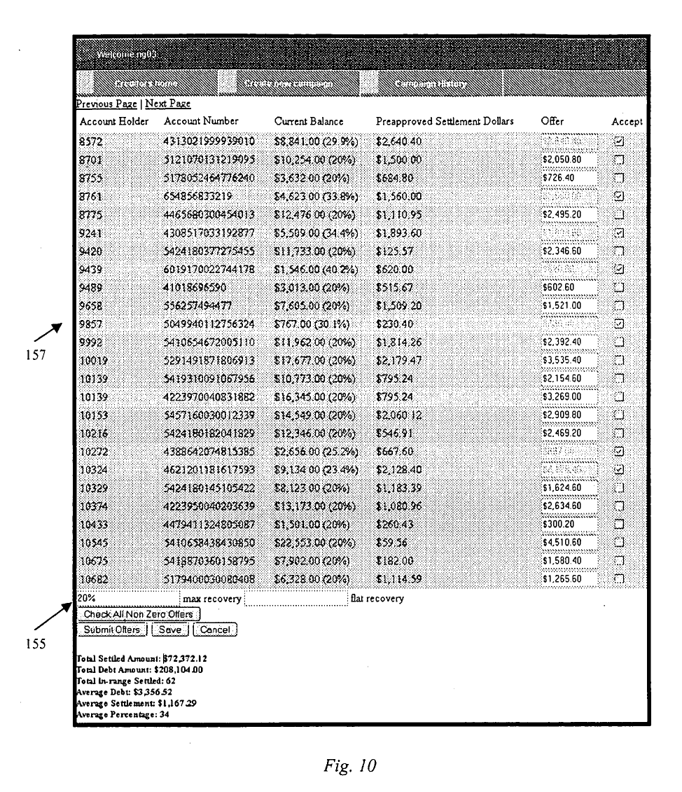

By way of further example, the screenshot of FIG. 10 is of a representative campaign, in one of the many forms/reports a creditor may use in connection with the Creditor interface of various embodiments of the invention. In that example, the Creditor inputs 20% as a “screening” parameter (in field 155), in order to see what debtor accounts (belonging to this Creditor) were ones on which the Debtor had offered (and/or accumulated) at least 20% of the balance owed. Among other things, this embodiment of the invention treats the Creditor's 20% parameter 155 as automatically including amounts (accumulated balances) GREATER than 20%, so the “results” 157 returned to the screen for viewing by the Creditor include some in excess of 20%.

For example, the top line of the results 157 in the screenshot of FIG. 10 indicates that 29.9% is authorized by that Debtor (Debtor Account Number 4313021999939010) and/or is available for the Creditor to accept. As shown by other records within those results 157, the results include all accounts for which the Debtor has authorized 20% or more of the original balance owed by that Debtor (in the example of FIG. 10, the eighth result even has 40.2% authorized/accumulated). Embodiments incorporating this feature therefore ensure the Creditor that the Creditor will not be “leaving any money on the table” when the Creditor makes a “bulk” settlement proposal for a batch of debts at a given percentage.

Data Interchange. In many embodiments, the invention preferably is integrated with other systems and networks, to facilitate easy adoption and use by the various participants. For example, certain embodiments preferably will be integrated to interact with Fair Isaac's SCORENET, Noteworld, and/or various third party trust vendor accounts, in order to facilitate automatic payment to creditors upon acceptance of a settlement offer.

In certain embodiments, the Creditor can be provided the option to receive this payment as a “lump sum” or as a payment over time. A tool can be provided which allows the Creditor to select which offers are to be “lump sum” payments and which offers are to be payments over time.

In at least most of its embodiments, the system as a whole preferably will require minimal human intervention to run smoothly. Among other things, the database portion of the invention preferably will automatically accept requests to settle if those requests fall within the parameters established by the debt settlement company (or the Debtor). Offers that are instead outside those parameters will be visible through the Debtor portal, but will only be “accepted” if the DSC/Debtor agrees to those different parameters being proposed by the Creditor.

Thus, the invention provides a variety of benefits:

For The Debt Settlement Company: In certain embodiments, the invention allows a debt settlement company to receive (in bulk) settlement requests from creditors/collection agencies, and to process those requests online. Specifically, the invention can provide:
Better Settlement amounts (lower amounts paid by the DSC/Debtor). Since the invention allows creditors to withdraw the maximum available funds from the TPTVs or other sources, this can translate to overall lower settlement percentages in many cases (in other words, for some debtors, a creditor may elect to take a lower settlement amount than if the creditor/debtor were not using the invention; see discussion below regarding “For the Creditor/Collection Agency”). In addition, all “automated/bulk” settlements can be capped at a percentage or other criteria designated by the debt settlement company (and/or by the relevant Debtor). By way of further description, by showing to the Creditor(s) the relevant funds that are available for a plurality of debtors, the invention allows Creditors to hit their overall total cash recovery goals, irrespective of the settlement amounts for any given individual debtor. For example, when a collector/collection agency has purchased a portfolio of debt, he can use certain embodiments of the invention to achieve a desired recovery or return on investment, not by attempting to maximize each individual settlement (which is a time consuming and resource intensive approach), but instead by using the invention's methods and apparatus to display how much money is available to collect across the entire portfolio (or some “campaign” the collector has designated from within that portfolio). Thus, in such situations, the invention can permit a Creditor to achieve his overall dollar goal, while the individual settlement amounts and/or percentages may be lower on average (or for any specific individual debt) than they might otherwise be if processed “manually”. Another of the many ways that percentages might be reduced (for any given individual debtor) is for the Creditor to use the system of the invention to display accounts that are close to the Creditor's target. For example, if a debtor/customer has 34% of the debt balance saved instead of the Creditor's target of 35% for a given campaign, the Creditor may decide to take those available dollars (34%, etc.) that are less then but close to his target amount (35%, etc.).
Lower Personnel costs. Because the invention preferably permits these renegotiations/settlements to be done in bulk and in an automated manner, the DSC saves money and time and human labor, by avoiding lengthy telephone conversations or other communications/negotiations for individual settlements.
Increased exposure to Creditors. All debt settlement companies benefit from having their companies and accounts visible to creditors with whom they previously may not have established a strong relationship.

For the Creditor/Collection Agency: The invention allows creditors to automate collection efforts, and to simplify the process of dealing with a multitude of debt settlement organizations (DSCs) and/or Debtors. In certain embodiments, the invention preferably works on a “campaign” methodology, in which a creditor/collector submits a batch of accounts to the Database Software 10, and then utilizes one or more of the “batch” settlement methods provided by the system. In one embodiment, those “batch” settlement methods can include, by way of examples:
Individual Settlement Offers. The creditor may make individual settlement offers of differing percentages on any or all accounts in the campaign. Preferably, the creditor has some visibility into how much money is available to settle an individual debtor's account, so that the Creditor may “cherry pick” individual debtor accounts to settle. Also, as noted above, the invention preferably does not display to a creditor the total assets that a consumer has; only a percentage not to exceed what a specific debt settlement company (and/or the Debtor) is willing to offer as a basis to settle (i.e. pay) a given debt/account.
Bulk Percentage Settlements. The creditor can offer a single percentage to all accounts in the campaign, and those that a) have the monies and b) fall within the acceptable parameters set by the debt settlement company will be accepted. Other offers will be passed to the debt settlement companies (and/or the Debtor) so they are aware of the offer and can elect to reconsider and possibly adjust the parameters on a particular debt account.
Maximum Recovery. The system preferably can determine and display to the Creditor all monies available from all consumers in a given campaign by that Creditor, and allow the Creditor to either extract the maximum amount of monies, or only take the maximum settlement percentages, or some balance between the two. In various embodiments, the Creditor can review various approaches in this regard by using a single slider interface or similar tool on the Creditor portal, for example. This gives the creditor a useful tool to maximize cash flow or profit, depending on the goals of the Creditor/organization at that moment.

Another of the many benefits of various embodiments of the Creditor portal is that the portal can provide to Creditors an insight into the overall status of a specific consumer's efforts to mitigate and settle that consumer's debt. A given debtor/consumer may have more then one creditor, and as the Debtor saves funds (via a TPTV or otherwise) to settle the Debtor's debts, oftentimes a creditor willing to accept the lowest settlement amount/percentage can receive those funds first (prior to other of that debtor's creditors). Preferably, the creditor portal will use a color coding system or other indicator to indicate how a consumer's savings relate not only to the viewing creditor, but how the savings relate to all of that debtor/consumer's debts.

For example, assume a debtor/consumer has two creditors, A and B. The consumer owes $1000 to Creditor A and $2000 to Creditor B. In a TPTV account or otherwise, the consumer has saved $400 towards settling those two debts. If the DSC or Debtor has authorized in the Database Software 10 a maximum 40% settlement amount (hoping that one or both Creditors will agree to take 40% of the debt that would otherwise be owed), the Database Software 10 preferably can display in the Creditor portal the “Creditor A account” in green (or with some other indicator) to indicate that the account is a possible “go”. That debt balance is a “go” because the debtor has both (1) authorized an amount of that debt that the debtor is willing to pay immediately to settle it, and (2) a sufficient balance to pay that authorized amount. The color or other indication on the Creditor portal report/display/etc. can alert Creditor A that Creditor A can consider settling with this client immediately (to do so, Creditor A would have to agree to the 40% authorized by the Debtor/DSC—$400 out of the $1,000 owed). In contrast, if Creditor B were to review the information available to Creditor B via the Creditor portal of the invention (at the same time that the $400 balance is available for payment of that debtor's debts), Creditor B's account for the same debtor/consumer preferably would not be shown “in green” (or other code/indicator of “go”). Instead, Creditor B's indicator/code would show that the debtor/consumer only had 20% of the balance saved ($400 out of the $2,000 owed). Accordingly, that “Creditor B account” could be displayed in red (or with some other “negative” indicator) to indicate that another “anonymous” creditor in the system is now in a position to take all or a portion of the debtor's monies available for settlement (assuming that the other creditor will “accept” the settlement terms that the debtor has proposed for that other creditor's debt). As a consequence, a creditor in the position of Creditor B can consider settling Creditor B's account promptly (before Creditor A does), in order to be sure of getting paid at least some money.

Although the invention can be practiced in a wide variety of embodiments, one such approach would be for the foregoing Creditor A to only see debt that “belongs” to Creditor A (e.g., debt data that has been uploaded by Creditor A or by nature of issuance (such as in the case of a bank/original creditor) belongs to Creditor A). In such embodiments, no creditor actually sees debt/accounts/details/amounts relating to another creditor, but instead only sees the colors or other coding system that provide a general inference as to the status of other accounts in the system relative to a given debtor.

Other indicators and presentation of data can be included in a wide variety of useful forms and reports within the system of the invention. Among other things, color coding or other indicators (such as the red/green/other color indicators described above) can provide creditors a quick and easy visual insight as to what may happen with particular accounts. In the above example, Creditor B may decide that it is in their best interest to settle with the consumer/debtor for the 20% payment “now”, knowing that the available payment monies are likely to drop to zero in the immediate future (when the debtor/consumer settles with the other creditor, Creditor A). Such embodiments of the invention can establish almost a competitive vying system amongst the creditors (bidding for the money currently available from the TPTV, for example).

In certain embodiments of the invention, a given creditor can be restricted to only see accounts that it has uploaded. However, various embodiments of the invention may also allow such a creditor to be able to view “coding” of that creditor's accounts (such as color coding), where such coding is based on some or all of the other accounts in the system related to that particular debtor. In such an embodiment, Creditor A would not see Creditor B's account for a debtor that was common to both Creditor A and B (and vice versa), but the color coding for each creditor can be influenced by (and reflect the relative status of) the other data or credit card balances in the system.

Further regarding the creditor portal, certain embodiments of the invention can include the ability to distinguish between an original creditor and a collection agency. For example, when using a portal to log into the database of the invention, a collection agency may be required to upload a list of accounts to start a campaign (which commonly can be from multiple original creditors). The collection agency's review and use of information within the database normally might be limited to only those accounts for which it had done the uploading. In contrast, an original creditor (Citibank, for example) could use the invention to do a “maximum recovery” style search on all credit cards that it issued, regardless of whether that original creditor had assigned those card collection matters to a creditor collection agency or other party, or instead was still “holding” those debts for potential collection/negotiation.

As mentioned above, the database of the invention preferably can be integrated with TPTVs (such as Fair Isaac's SCORENET, for example). Depending on the degree of integration in any particular embodiment, this can allow major creditors to directly integrate their back-end systems with the database of the invention, to the point of even bypassing the creditor portal. With a never-before-seen visibility into the consumer's debt settlement efforts, the invention thus provides major creditors the ability to retain consumer debt rather then selling it off (usually at a discount) or taking other action to try to collect same (which may include some negative consequence to the consumer's credit rating, etc.). This increases not only the likelihood of a greater return of dollars to the creditor, but the ability to retain a good relationship with the consumer/debtor.

Embodiments that include such partnering with TPTVs also allow the invention data to begin to be used in credit scoring within the overall credit industry. By establishing an independently accountable database of debt negotiation consumer/debtor behavior, the invention provides the ability to more easily allow consumers/debtors to make it through a difficult time in their economic lives and return as viable creditworthy consumers.

As indicated above, many alternative embodiments of the invention can be practiced. By way of further example and not by way of limitation, debtors could upload their debt information directly to the database(s), rather than through a DSC or other agent. The invention can be practiced without any neutral third party such as the third party trust vendor. To some degree, the invention may even have utility for a single debtor/DSC and/or a single creditor, although the utility generally would appear to be greater in some proportion to the number of separate “debts” to be renegotiated/administered/etc.

The invention could be administered in any suitable manner, including without limitation the preferable secure use of a network, the Internet, or a VPN (virtual private network), among others. Among other alternatives to creditor uploading proposals “as a campaign”, one or more creditors could have a direct connection to the database, whereby every account moving through a creditor's system could be “scrubbed” by the database service/apparatus as part of the creditor's decisioning engine. Under such an embodiment, the invention would be practiced without “campaigns” but instead with a steady flow of information between the creditor and the database.

Other embodiments can include a “reverse scrubbing” approach, in which the database service/apparatus sends selected debt information (uploaded to the database by the debtor(s)/DSC(s)) to one or more creditors. The creditor(s) can then “scrub” this information against the creditor's own database (to see if any of the selected debt information that was sent is for their account(s) and/or meets their criteria for possible settlement offers. After that “reverse scrubbing” and any further analysis and or decision-making by the creditor, the creditor then generates and returns to the database service/apparatus any settlement offers the creditor wishes to make, so that the debtor/DSC can review any such offers.

Still other of the many alternative embodiments would include having more than one third party trust vendor, any of a variety of self-saver models (where the debtor saves without a third party trust vendor), and/or combinations and permutations of the two.

Other of the many embodiments of the invention include providing a “preference” to certain Creditors, such as the first creditor to have its account enrolled for a given Debtor will be given some degree of preference (over other Creditors of that Debtor) as to payments from that Debtor. In any case, the invention preferably provides an improved (e.g., more time- and cost-efficient, as well as more flexible and automated) method and apparatus for Creditors to collect on certain debt accounts, as compared to prior art systems.

In many embodiments, the selection of the TPTV is no more important than selecting an overnight delivery service. The “settlements” should go through whichever vendor a DSC or consumer is using, and the level of automation for communications and actions between the database and the vendor can likewise vary, depending (for example) on volume of transactions being handled by that TPTV.

A further benefit of the invention is that, if a DSC goes out of business for any reason, the relevant “clients” of that DSC (those debtors for whom the DSC was using the invention as a tool to resolve debts) can be readily “plugged directly into” the database of the invention. In other words, if the DSC drops out of the process and is no longer functioning as an intermediary between the database/Creditor(s) and the Debtor, that Debtor preferably can pick up the process and interface with the database similarly or identical to the way that the DSC had been doing.

The database of the invention preferably is secured by appropriate safeguards, including technology and/or standards such as by Payment Card Industry (PCI) Data Security Standards. Among other things, this can help ensure that potentially sensitive information pertaining to consumers/debtors is protected from fraud, cracking, and various other security vulnerabilities and threats that exist whenever debtor data is electronically stored, processed, and/or transmitted.

Persons of ordinary skill in the art will understand that the present invention may have utility in a wide variety of applications, including for potentially any form of debt.

Some states regulate or otherwise have legislation affecting DSCs. Depending on any particular DSC's activities and location, various embodiments of the invention may help reduce or even eliminate various regulatory issues (especially if the DSC is operating in multiple states or other jurisdictions), and/or help the DSC to comply with any such regulations.

Although the methods of the present invention are described with steps occurring generally in a certain order, the specific order of the steps, or any continuation or interruption between steps, is not required.

The apparatus and methods of the present invention have been described with some particularity, but the specific designs, constructions and steps disclosed are not to be taken as delimiting of the invention. Modifications will be apparent and will not depart from the essence of the invention. All such changes and modifications are intended to be encompassed within the appended claims.

What is claimed is:

1. Apparatus, including a computer database for receiving and processing information related to debt relationships, said information including the amount of the debt, the identity of the creditor, and the identity of the debtor; said database being configured to receive such information from multiple debtors and from multiple creditors, said database further configured to receive proposed revised payment parameters from the debtor(s) and/or the creditor(s) and permit controlled review of those parameters by the relevant creditor(s) and/or debtor(s) associated with the underlying debt, the relevant debtor, and/or the relevant creditor.

2. The apparatus of claim 1, in which said database further comprises information related to trust balances associated with a selected debtor, said balances indicating monies available to satisfy some or all of the debtor's debts contained within the database.

3. The apparatus of claim 1, in which said database further comprises a creditor portal that allows a creditor to view certain debtor accounts according to criteria selected by the creditor, and to calculate related payment outcomes based on criteria selected by the creditor.

4. The apparatus of claim 1, further comprising a network on which the database is hosted, said apparatus further providing secure access to the database by relevant creditors and/or debtors.

5. A method of renegotiating debt, comprising the steps of:
providing the apparatus of claim 4;
providing a suitably secure web portal or other interface for debtor/creditor interaction with the apparatus:
at least one debtor uploading debt/account information and/or proposed revised payment terms for same into the database of said apparatus;
providing to at least one creditor at least one form or report to help the creditor consider at least one proposed settlement or renegotiation strategy or offer for one or for many debt accounts;
said creditor selecting at least one of the proposed settlement or renegotiation strategies.

6. The method of claim 5, further comprising the steps of the debtor and/or creditor setting parameters for acceptable settlement/renegotiated terms for the debt.

7. The method of claim 5, further comprising the steps of providing in the database trust balance information related to the debt(s), and the debtor setting parameters for what amount of the relevant balance will be viewable to the relevant creditor and/or available to resolve the debtor's debt(s).

8. An apparatus for renegotiating debt, comprising:
a database for receiving and processing information related to debt relationships;
a debtor portal that allows a debtor to interact with the database, said database configured to generate debtor settlement terms based on parameters selected by the debtor; and
a creditor portal that allows a creditor to interact with the database, said database configured to generate creditor settlement terms based on parameters selected by the creditor.

9. The apparatus of claim 8, wherein said information includes the amount of debt, the identity of the creditor, and the identity of the debtor.

10. The apparatus of claim 9, wherein said information further includes trust balances related to the debtor's debt, said balances indicating monies available to satisfy some or all of the debtor's debts contained within the database.

11. The apparatus of claim 9, wherein said information further includes estimated balances related to the debtor's debt, said balances indicating monies available to satisfy some or all of the debtor's debts contained within the database.

12. The apparatus of claim 9 or claim 10 or claim 11, in which said database is configured to receive such information from multiple debtors and from multiple creditors.

13. The apparatus of claim 12, said debtor portal further including means to allow the debtor to input debt information into the data base, to review proposed payment parameters, and to revise those proposed payment parameters according to criteria selected by the debtor; and wherein said creditor portal allows the creditor to input debt information into the database, to review proposed revised payment parameters, and to revise related payment parameters based on criteria selected by the creditor.

14. The apparatus of claim 12, said creditor portal further including means to allow the creditor to review certain debtor accounts according to parameters selected by the creditor, and to calculate related payment outcomes based on parameters selected by the creditor.

15. The apparatus of claim 11, further including means for calculating said estimated balances related to the debtor's debt.
